(19) United States
(12) Patent Application Publication
(10) Pub. No.: US 2003/0140236 A1
(43) Pub. Date: Jul. 24, 2003

(54) Method and arrangement for preventing unauthorized execution of computer programs and a corresponding software product and a corresponding computer-legible storage medium

(76) Inventor: Detlef Mueller, Barsbuettel (DE)

Correspondence Address: PHILIPS ELECTRONICS NORTH AMERICAN CORP, 580 WHITE PLAINS RD, TARRYTOWN, NY, 10591, US

(21) Appl. No.: 10/320,271

(22) Filed: Dec. 16, 2002

(30) Foreign Application Priority Data
Dec. 19, 2001 (DE) 10162291.0

(51) Int. Cl. G06F 12/14

(52) U.S. Cl. 713/187

(57) ABSTRACT

The invention describes a method and an arrangement for preventing unauthorized execution of computer programs and a corresponding software product and a corresponding computer-legible storage medium which can be used in particular to secure self-tests based on the test ROM in Smartcards against unauthorized execution of these tests. The evaluation of the test procedure takes place by means of a signature register which records all code and data transfers and encrypts these together. The execution of the test ROM is generally regarded as highly security-relevant and is subject to various protective measures e.g. fuses. The invention extends these protective measures in that, on execution of the test ROM, new signatures are generated in the register. During the program execution of the test ROM, the content (or an individual bit) of the signature register is compared with a signal supplied via an I/O pad. If the bit from the signature register and the externally entered signal differ, a reset is triggered. Execution of the test ROM is therefore possible only if the internally generated signature is known. Security-relevant processes in the test ROM execution can thus be effectively protected.

The invention relates to a method and an arrangement for preventing unauthorized execution of computer programs and a corresponding software product and a corresponding computer-legible storage medium which can be used in particular to secure a test ROM-based self-test against unauthorized execution in the production of Smartcards.

The development of microelectronics in the 1970's allowed the production of small computers in credit card format without user interface. Such computers are known as Smartcards. A Smartcard integrates a data memory and arithmetic logic unit in a single chip of a few square millimeters in size. Smartcards are used in particular as telephone cards, GSM SIM cards, in the banking sector and in the health sector. The Smartcard has thus become a ubiquitous computer platform.

Smartcards are at present mainly regarded as a secure storage site for secret data and as a secure execution platform for cryptographic algorithms. The assumption of relatively high security of the data and algorithms on the card lies in the hardware construction of the card and the external interfaces. Externally the card constitutes a “black box”, the functionality of which can be accessed only via a well-defined hardware and software interface and which can enforce certain security policies. Firstly access to data can be linked to particular conditions. Critical data e.g. secret keys of a public key process can even be withdrawn completely from external access. Secondly a Smartcard is able to execute algorithms without the execution of the individual operations being observable externally. The algorithms themselves can be protected on the card against change and reading. In the object-oriented sense the Smartcard can be regarded as an abstract data type which has a well-defined interface, a specific behavior and is even able to ensure the observation of particular integrity conditions in relation to its status.

There are essentially two different types of Smartcards. Memory cards have only a serial interface, an address and security logic, and ROM and EEPROM memories. These cards have only restricted functionality and serve a specific purpose. Therefore they are particularly cheap to produce. Smartcards produced as microprocessor cards in principle constitute a complete universal computer.

The production and delivery method for chip cards breaks down into the following phases:

production of a semi-conductor,

embedding of the semi-conductor,

printing of the card,

personalization of the card,

issue of the card.

Generally each phase is performed by a company specializing in the work concerned. For production of semi-conductors, in particular on cards with hard-wired security logic, good internal company security must be ensured. In order for the manufacturer to be able to perform a correct end test, the complete memory must be freely accessible. Only after the end test is the chip secured by a transport code. Thereafter access to the card memory is possible only for authorized parties who know the transport code. The theft of brand new semi-conductors is therefore inconsequential. Authorized parties can be the personalizer or card issuer. No further security functions are necessary for embedding and printing. The companies concerned need not know the transport code.

Generally it is not the card manufacturer but the issuing party (e.g. bank, telephone company, hospital etc.) who transfers the person-specific data to the card. This process is called personalizing. It is necessary to know the transport code for this.

The issue of cards i.e. transport from the issuing point to the card holder constitutes a further security problem. More precisely only the personal issue to the card holder against signature and presentation of identity is secure. Dispatch by post is often more economic but also relatively insecure. Another problem is the transmission of the PIN number to the card holder, and here the same care must apply as to the cards.

Due to the important security-relevant content of the memory on the Smartcard controllers, as well as observation of these security measures additional protection against possible activities of hackers must be guaranteed, extending to all phases of life of a Smartcard—starting with production, transport, use of the card through to processing of cards which have become unusable.

One possibility of accessing secret information is to arrange a self-test from a test ROM in the Smartcard controllers. Self-tests from a test ROM are performed in Smartcard controllers for functional testing of the circuit during the production test. The test procedure is analyzed by means of a signature register which records and encrypts together all code and data transfers. The result of a test is then a signature comprising several bytes. Execution of the test ROM is generally regarded as highly security-relevant and is subject to various static protection measures (e.g. fuses). The execution of test ROMs is prevented by various static measures, e.g. fuses, or low dynamic security.

If these static or low dynamic protective measures against unauthorized execution of the test ROM can be avoided, execution of the test ROM is possible including any security-relevant routines.

The invention is therefore based on the object of producing a method, an arrangement and a corresponding software product and corresponding computer-legible storage medium of the generic type by means of which the disadvantages of the conventional protection measures, in particular static or low dynamic security, can be avoided and unauthorized execution of software prevented in a simple and efficient manner.

According to the invention this object is achieved by the features of the characteristic parts of claims 1, 11, 13 and 14 appendant to the features of the preamble. Suitable embodiments of the invention are defined in the sub-claims.

One particular advantage of the method of preventing unauthorized execution of computer programs is that, during execution of the program, signature data are generated at prespecifiable time cycles, at least part of the signature data being compared with data supplied externally to the computer program and, execution of the computer program being interrupted in the case of non-conformity of the data to be compared.

An arrangement for preventing unauthorized execution of software is advantageously designed so that it comprises a processor designed such that unauthorized execution of computer programs can be prevented in that, during execution of the program, signature data are generated at prespecifiable time cycles, at least part of the signature data being compared with data supplied externally to the computer program and execution of the computer program is interrupted in the case of non-conformity of the data to be compared.

A software product for preventing unauthorized execution of computer programs comprises a computer-legible storage medium on which a program is stored which, after being loaded in the memory of a computer or Smartcard controller, allows the computer or Smartcard controller to prevent unauthorized execution of computer programs in that during execution of the program, signature data are generated at prespecifiable time cycles, at least part of the signature data being compared with data supplied externally to the computer program and, execution of the computer program being interrupted in the case of non-conformity of the data to be compared.

To prevent unauthorized access to computer programs, advantageously a computer-legible storage medium is used on which a program is stored which, after loading in the memory of a computer or the Smartcard controller, allows the computer or Smartcard controller to prevent unauthorized execution of computer programs in that, during execution of the program, signature data are generated at prespecifiable time cycles, at least part of the signature data being compared with data supplied externally to the computer program and execution of the computer program being interrupted in the case of non-conformity of the data to be compared.

A further advantage of the method according to the invention is that the time cycles for generation of the signature data are preset by system clocks.

In a preferred embodiment of the method according to the invention a comparison of the signature data is made at each prespecifiable time cycle.

It has proved advantageous for the signature data to be generated in that code and data transfers performed on program execution are recorded and encrypted together.

For further use the signature data can be stored in a signature register.

In addition, in a preferred embodiment of the invention, for each system clock a single bit from the signature register is compared with a signal supplied externally.

An advantageous embodiment of the invention method is characterized in that in the case of non-conformity of the data to be compared, the execution of the software is interrupted in that a reset is triggered immediately.

In a further preferred embodiment of the invention, the external data is supplied via an I/O pad.

To prevent unauthorized execution of software it can be advantageous for a signature comparison to take place only for a restricted part of the address area in the test ROM.

In a preferred application of the method according to the invention, the computer program to be protected performs a self-test from a test ROM of a Smartcard controller.

In addition, in a preferred embodiment of the arrangement according to the invention, the processor is part of a Smartcard controller and the arrangement is a Smartcard.

The particular advantage of the invention is particular that in general this internal signature of the self-test is known only to the manufacturer, thus achieving an essential improvement in the security-relevant procedures.

The invention will now be explained in more detail below in an embodiment of a test ROM-based self-test.

In contrast to conventional processes, in the invention not only a signature is generated and stored in a signature register, but the securing e.g. of a test ROM-based self-test against unauthorized execution comprises a multiple defined change of the signature by an external supply of the signature. This achieves a dynamic test ROM protection. The execution of the test ROM generates a new signature in the signature register for each system clock. The additional protection of execution of the test ROM lies in that during program execution of the test ROM, for each system clock a single bit of the signature register is compared with a signal supplied via an IO pad. If the bit from the signature register and the externally supplied bit differ, a reset is triggered immediately. Execution of the test ROM is therefore possible only if the internally generated signature is known, which is the case only for the manufacturer. To complete asynchronous processes, the signature comparison can where applicable be limited to a particular address area in the test ROM. In particular security-relevant processes in the test ROM execution can thus be effectively protected.

The invention is not restricted to the embodiments shown here. Rather it is possible by combination and modification of the said means and features to implement further embodiment variants without leaving the framework of the invention.

1. A method for prevention of unauthorized execution of computer programs, characterized in that, during execution of a computer program, signature data are generated at prespecifiable time cycles, at least part of this signature data being compared with data supplied externally to the computer program and execution of the computer program being interrupted in the case of non-conformity of the data to be compared.

2. A method as claimed in claim 1, characterized in that the time cycles for generating signature data are prespecified by system clocks.

3. A method as claimed in any one of the preceding claims, characterized in that a comparison is performed at each prespecifiable time cycle.

4. A method as claimed in any one of the preceding claims, characterized in that the signature data are generated in that the code and data transfers performed on program execution are recorded and encrypted together.

5. A method as claimed in any one of the preceding claims, characterized in that the signature data are stored in a signature register.

6. A method as claimed in any one of the preceding claims, characterized in that, for each system clock, a single bit from the signature register is compared with an externally supplied signal.

7. A method as claimed in anyone of the preceding claims, characterized in that, in the case of non-conformity of the data to be compared, execution of the computer program is interrupted in that a reset is triggered immediately.

8. A method as claimed in any one of the preceding claims, characterized in that the external data is supplied via an I/O pad.

9. A method as claimed in any one of the preceding claims, characterized in that a signature comparison is performed only for a restricted part of the address area in the test ROM.

10. A method as claimed in any one of the preceding claims, characterized in that the computer program performs a self-test from a test ROM of a Smartcard controller.

11. An arrangement with a processor designed such that unauthorized execution of computer programs can be prevented in that, during execution of a computer program, signature data are generated at prespecifiable time cycles, at least part of the signature data being compared with data supplied externally to the computer program and execution of the computer program being interrupted in the case of non-conformity of the data to be compared.

12. An arrangement with a processor as claimed in claim 11, characterized in that the processor is part of a Smartcard controller and the arrangement is a Smartcard.

13. A software product which comprises a computer-legible storage medium on which a program is stored which, after being loaded in the memory of a computer or Smartcard controller, allows the computer or Smartcard controller to prevent the unauthorized execution of computer programs in that, during execution of a computer program, signature data are generated at prespecifiable time cycles, at least part of the signature data being compared with data supplied externally to the computer program and execution of the computer program being interrupted in the case of non-conformity of the data to be compared.

14. A computer-legible storage medium on which a program is stored which, after being loaded in the memory of a computer or Smartcard controller, allows the computer or Smartcard controller to prevent the unauthorized execution of computer programs in that during execution of a computer program, signature data are generated at prespecifiable time cycles, at least part of the signature data being compared with data supplied externally to the computer program and execution of the computer program being interrupted in the case of non-conformity of the data to be compared.
